(19) United States
(12) Patent Application Publication
(10) Pub. No.: US 2025/0326590 A1
(43) Pub. Date: Oct. 23, 2025

(54) LIFTING DEVICE FOR MANIPULATING A LOAD AND METHOD FOR MANIPULATING A LOAD

(71) Applicant: EFS - Gesellschaft für Hebe- und Handhabungstechnik mbH, Nordheim (DE)

(72) Inventor: Aaron Geenen, Schwaigern (DE)

(21) Appl. No.: 19/180,500

(22) Filed: Apr. 16, 2025

(30) Foreign Application Priority Data
Apr. 22, 2024 (DE) 10 2024 111 177.1

(51) Int. Cl. B65G 47/90

(52) U.S. Cl. CPC B65G 47/90

(57) ABSTRACT

A lifting device (01) for manipulating a load (06), the lifting device (01) comprising a multiaxial kinematic mechanism (04) on which at least one manipulator arm (02) is mounted, the manipulator arm (02) being configured to move about and/or along multiple axes of movement (41, 42, 43, 44, 45) and having a holding means (05) for the load (06), wherein a positioning unit (07, 08, 09, 10, 11) acting on the multiaxial kinematic mechanism (04) and serving to move the manipulator arm (02) and a weight compensation unit (12, 13) for compensating for the weight force (FG) of the load (06) are associated with at least one of the axes of movement (41, 42, 43, 44, 45). Furthermore, a method for manipulating a load by means of at least one lifting device (01) is disclosed.

This application claims the benefit of German Patent Application No. 10 2024 111 177.1 Filed on Apr. 22, 2024, the disclosure of which is incorporated by reference.

### TECHNICAL FIELD

The present invention relates to a lifting device for manipulating a load and a method for manipulating a load.

### BACKGROUND

When assembling components or assemblies, for example in the automotive industry, they must be brought to the desired location and handled there for assembly. Lifting devices can be used in particular for components, assemblies or other loads with a relatively high weight to relieve the worker. With generic lifting devices, which are regularly also referred to as hoists, loads can be manually manipulated and thus can be brought into a desired position.

For example, known lifting devices can comprise a manipulator arm mounted to pivot on an associated pivot joint having a vertical pivot axis, the manipulator arm having a holding means for holding the load. To compensate for the weight force of the load, the manipulator arm can be connected to a piston-cylinder module acting against the weight force so that the worker has to apply as little force as possible when positioning the load. Furthermore, it is known from EP 2 295 209 A1, for example, to provide an auxiliary drive for easy pivoting of the manipulator arm, which can be controlled by the user, in particular for handling heavy loads.

However, the known lifting devices are disadvantageous in that the interaction between the worker and the lifting device, in particular in connection with large loads, carries risks of injury to the worker or damage to the load. Furthermore, a known auxiliary drive used to pivot a manipulator arm must provide a relatively high drive force or drive energy.

In addition to generic lifting devices, which are typically operated manually, fully automated systems equipped with articulated robots, for example, for handling a load are known. However, fully automated systems of this kind are associated with high investment costs and are relatively inflexible in terms of their possible uses and adaptations.

There is therefore a great need for a lifting device and a method for manipulating a load, the load being supposed to be moved as reliably, safely and smoothly as possible and with minimal energy consumption. In addition, the lifting device should be flexible, as universally applicable as possible and adaptable to different tasks and problems. Furthermore, the lifting device should be cost-effective to produce and operate, and the method should be cost-effective to implement, with a further focus being placed on a design of the lifting device being as compact and space-saving as possible. Furthermore, it is imperative that the protection of the worker operating the lifting device be ensured, and integration into existing protective installations in the sense of retrofitting ought to be possible.

Hence, the object of the invention is to provide a lifting device and a method of this kind that overcome the disadvantages of the prior art in the process while consuming as little energy as possible.

This object is attained in a surprisingly simple but effective manner by a lifting device for manipulating a load according to the teaching of and a method for manipulating a load.

In a first aspect, the invention relates to a lifting device for manipulating a load, the lifting device comprising a multiaxial kinematic mechanism on which at least one manipulator arm is mounted. The manipulator arm has a holding means for the load and can be moved about multiple axes of movement and/or along multiple axes of movement by means of the multiaxial kinematic mechanism. For instance, the load can be moved linearly along an axis of movement and/or can be pivoted about an axis of movement.

In the context of the invention, a multiaxial kinematic mechanism refers to a kinematic system that has multiple links that can move relative to one another and that can be moved relative to one another in a rotational or translational manner by means of joints. A drive and/or actuator can be assigned to the joints. The multiaxial kinematic mechanism according to the invention can comprise the manipulator arm. That is to say that the manipulator arm can be part of the multiaxial kinematic mechanism.

The lifting device according to the invention is characterized in that a positioning unit acting on the kinematic system in order to move the manipulator arm and a weight compensation unit are associated with at least one of the axes of movement. In other words, this means a positioning unit and a weight compensation unit are associated with each axis of movement, such as a translational axis and/or a rotational axis, along and/or about which movement of the manipulator arm is intended. Thus, a linear movement and/or pivoting of the manipulator arm can be achieved while minimizing the drive energy of the positioning unit provided for the axis of movement in question. This is because the weight forces occurring at said axis of movement and caused by the load can be dynamically compensated for by means of the weight compensation unit also associated with the axis of movement in question, with the result that the drive energy supplied to the positioning unit in question can be significantly reduced for the individual axis of movement. This means that a movement of the manipulator arm about and/or along an axis of movement is opposed by only a minimal weight force or no weight force owing to the weight compensation by means of the weight compensation unit, which means that a movement of the manipulator arm for manipulating the load by means of the positioning unit can take place with as little drive energy as possible. For one, this allows for energy-efficient and flexible handling of the load while increasing safety for the worker at the same time since the load is only moved by low forces and torques even in the event of a malfunction, which means that no damage or only minor damage can be caused by the load. Furthermore, the safety of the operating personnel can be increased by the fact that the lifting device according to the invention can be easily integrated into established protective installations. The arrangement according to the invention therefore combines the advantages of known lifting devices for manually manipulating a load with the possibility of targeted and defined support for the worker when moving the manipulator arm about and/or along multiple axes of movement owing to the multiaxial kinematic mechanism and the positioning unit.

The positioning unit has at least one positioning actuator, which is supplied with drive energy to position the load. The weight compensation unit has at least one weight compensation actuator, which is supplied with drive energy to compensate for the weight force of the load. In the context of the invention, the term “actuator” refers to a drive unit that converts an electrical signal into mechanical motion.

The manipulation of the load can preferably take place manually or semi-automatically. If the load is manipulated semi-automatically, the worker is partially supported by automation while no full autonomy of the process flow is achieved, which can save investment costs and planning effort and can increase flexibility. However, it is also conceivable for the manipulation of the load by means of the lifting device according to the invention to take place in a fully automated manner, complete autonomy of the process flow or complete relief of the worker being achieved and the worker merely having a monitoring function.

In addition, it is conceivable for known generic lifting devices to be retrofitted to a lifting device according to the invention. The configuration of the lifting device according to the invention allows such a retrofitting with relatively little investment.

Furthermore, it has proven advantageous in the context of the invention that a weight compensation unit and a positioning unit are provided for each axis of movement since this allows flexible adaptation of the lifting device to the load to be manipulated and to the sequence of movements for positioning the load.

Advantageous embodiments of the invention are the subject of the dependent claims. The scope of the invention also includes all combinations of at least two features disclosed in the description, the claims and/or the figures. It is understood that the statements made about the lifting device equivalently apply to the method according to the invention without being mentioned separately in its context. In particular, it is understood that linguistically common rephrasing and/or an analogous replacement of individual terms within the framework of common linguistic practice, in particular the use of synonyms supported by the generally recognized linguistic literature, are comprised by the content of the present disclosure without being explicitly mentioned in their respective written-out forms.

The weight compensation unit and/or the positioning unit can be configured to be driven electrically and/or pneumatically. In other words, the weight compensation unit and/or the positioning unit can have an electric and/or a pneumatic drive. Preferably, the weight compensation unit can have a weight compensation actuator that can be driven pneumatically. Further preferably, a positioning actuator of the positioning unit can be driven electrically. According to a preferred embodiment, the weight force of the load can be compensated for by means of pneumatic energy and the load can be positioned by means of electrical energy, whereby an energy-efficient load compensation and a high accuracy in positioning are achieved. In particular, the positioning unit can be driven by a position-controlled drive.

The electric and/or pneumatic drive of the weight compensation unit and/or of the positioning unit can be configured in such a manner that the drive meets the requirements of collaborative robotics. The lifting device is thus advantageously suited to work with a human operator in the same working space at the same time. In particular, the safety requirements of collaborative robotics can be met by means of the drive of the weight compensation unit and/or of the positioning unit. Thus, the lifting device can advantageously be used in the immediate vicinity of the human operator and can interact with the human operator, and injuries to the human operator can be ruled out. The working space of the lifting device can be monitored by sensors of the lifting device or external sensors, for example, meaning a structural safety installation for separating the lifting device from the human operator can be dispensed with since the lifting device can be automatically switched off in dangerous situations owing to the sensor monitoring.

According to a preferred embodiment of the invention, the lifting device can comprise a controller that is configured to control the movement of the manipulator arm as a function of the weight force of the load and/or of the position of the load and/or of the trajectory of the manipulator arm. In the context of the invention, the wording “trajectory of the manipulator arm” refers to the sequence of movements of the manipulator arm necessary for positioning the load, in particular moving to a plurality of positions in the working space over time. It is conceivable that the controller creates a set of control data for moving the manipulator arm as a function of the weight force of the load and/or of the position of the load and that the weight compensation unit and/or the positioning unit can be controlled by means of the set of control data. In addition to control commands for activating a weight compensation unit and/or a positioning unit, a set of control data can also contain information about the trajectory, i.e., the sequence of movements of the manipulator arm necessary for positioning the load. It is particularly advantageous if the positioning unit and the weight compensation unit are connected to each other through circuitry via the controller so that the weight compensation actuator and the positioning actuator can be controlled as a function of each other. This makes it possible in particular for the drive energy of the positioning actuator for moving the load to be continuously optimized, preferably kept constantly low, since, in the event of an increased supply of drive energy to the positioning actuator, the weight compensation actuator can be adjusted in such a manner that the positioning actuator is relieved.

In the context of the invention, it has advantageously been found that the weight force of the load, which is to be compensated for by means of the weight compensation unit, dynamically changes as a function of the sequence of movements of the manipulator arm and/or of the position of the load. This dynamic change of the weight force to be compensated for arises due to the movement of the load. According to a preferred embodiment, the weight compensation unit, in particular a weight compensation actuator, can be dynamically controlled by means of the controller to enable dynamic compensation of the weight force of the load. In other words, this means that depending on the position of the load and/or on the sequence of movements of the manipulator arm, the force exerted by the weight compensation unit can be adjusted in order to operate the positioning actuator of the positioning unit with as little energy as possible irrespective of the position of the load and/or of the sequence of movements of the manipulator arm.

The lifting device can comprise a position sensor system, a speed sensor system, an acceleration sensor system, a time sensor system, a path sensor system and/or a weight sensor system. The data collected by the aforementioned sensor systems can be transmitted to the controller and can be used by the controller to create a set of control data for the weight compensation unit and/or for the positioning unit. In other words, this means that the controller can create a set of control data as a function of the data determined by the aforementioned sensor systems. The position sensor system is configured to detect the position of the load in space relative to a zero point, which is preferably located on the lifting device. The speed sensor system can be used to detect the speed at which the load is being moved. The acceleration sensor system is used to detect the acceleration of the load during movement of the load. The time sensor system can be used to measure the time required for a certain sequence of movements when the load is being moved. The path sensor system is used to detect a distance traveled by the load. Thus, by combining a time sensor system and a path sensor system, it is possible to create what is referred to as a time-path diagram for certain sequences of movements of the load. However, it is also conceivable that a speed sensor system could be used to detect the distance traveled by the load over time since said speed sensor system can be configured to detect a defined distance per time. The weight sensor system can be used to determine the weight of the load disposed on the holding means of the manipulator arm. If the weight of the load is unknown, the weight compensation unit can be controlled as a function of the data from the weight sensor system to effectively and precisely compensate for the weight force of the load.

In order to ensure the safety of the worker and to avoid damaging the load, the weight compensation unit is configured in such a manner that a drop in energy or an interruption in the energy supply to the weight compensation unit will cause the load to remain in its current position and will ensure that the load cannot fall unintentionally. In particular, if the weight compensation unit comprises a pneumatically actuated piston-cylinder module, the cylinder can be held in the current stroke position when the energy supply is interrupted, for example due to a hose rupture and the associated pressure drop, in order to prevent the load from falling. For this purpose, the weight compensation unit can have a fall arrester. Preferably, the fall arrester can have a valve that is located in the pneumatic line leading to the piston-cylinder module and is connected in such a manner that the pressure medium can pass freely during the up and down stroke, whereas it jumps into the closed position in the event of a drop or loss of energy. In the closed position, the outflow of the pneumatic medium, usually compressed air, out of the piston-cylinder module is blocked and the load remains in the current stroke position. Thus, the fall arrester can ensure that the current stroke position is maintained in the event of a system failure or in the event of a power outage and that a fall of the load is avoided. The valve of the fall arrester automatically blocks in the event of a power failure, thus preventing the pneumatic fluid from flowing out of the piston-cylinder module. Alternatively or additionally, it is conceivable that the valve of the fall arrester has an aperture whose opening cross section is matched to the desired maximum lowering speed of the load. In other words, the aperture throttles the flow of the pneumatic medium in such a manner that the maximum lowering speed of the load is limited in the event of an interruption of the energy supply. This allows the load to be lowered gently in case of a drop in energy.

The multiaxial kinematic mechanism of the lifting device according to the invention can comprise a pivot joint associated with the manipulator arm, the pivot joint having a vertical pivot axis, the manipulator arm being able to pivot about the vertical pivot axis, and the manipulator arm being able to be mounted in a fixed place, in particular on a support element, by means of the associated pivot joint. The mounting in a fixed place ensures that the pivot axis of the associated pivot joint remains vertical and is therefore permanently free of external weight torques acting about the pivot axis. This ensures that the manual force of the worker and/or the force of the positioning unit essentially only have to exert the inertial forces of the load during acceleration or deceleration without having to perform lifting work against the force of gravity. This makes moving the arrangement easy and energy-efficient. A support element can be a supporting column that can be anchored to the ground, or a ceiling beam, or a trolley that can be moved along a ceiling rail, or a wall bracket, for example. It has also proven to be advantageous if the manipulator arm can pivot about the pivot joint without a rotation angle limitation. This allows access to all positioning locations located within the radius of the manipulator arm.

The manipulator arm of the lifting device can be formed by vertically pivoting parallelogram arms that are disposed one above the other in the direction of the weight force. This ensures that the assemblies externally connected to it, including one or more further pivot joints, do not perform a tilting movement when the height is adjusted. The vertical pivot axis of an outer pivot joint remains vertical and thus free of external weight torques.

A control module that can be operated by the worker can be located in the area of the holding means for the load. The favorable location of the control module allows the worker to continue to stand in the area of the holding means for the load and to manually and/or semi-automatically manipulate it into the desired orientation and position. At the same time, the worker also has direct access to the control module, by means of which the worker can control the manipulation of the load, in particular the positioning unit and/or the weight compensation unit. The worker can thus control the lifting device and can maintain direct contact with the load at the same time, thus being able to manually correct or adjust its orientation and position by manual force if necessary or desired. It is also conceivable for the control module to be wireless or wired in such a manner that the worker can move with the control module at least within and around the working area of the lifting device.

The lifting device can comprise a guide that allows the weight compensation unit to be shifted transversely to the longitudinal axis of the weight compensation unit. In particular, the guide can allow the piston-cylinder module of the weight compensation unit to be shifted transversely to the cylinder axis of the piston-cylinder module. The guide can have at least one, preferably at least two, rollers. The weight-compensating piston-cylinder module can be connected to the multiaxial kinematic mechanism in an articulated manner while being supported by the multiaxial kinematic mechanism or a support element of the lifting device, allowing the piston-cylinder module to follow the function of changing the pitch line distance of the load during a lifting movement by itself. If the guide advantageously comprises more than one roller, disturbances, for example due to dirt, and an inclined position of the cylinder can be effectively avoided. Advantageously, owing to the proposed guide, the effective distance to a parallel axis running through a pivot axis of the manipulator arm can thus change. Advantageously, the piston-cylinder module can be fixed in the guide in such a manner that it can be shifted between a load end of the manipulator arm and/or an element of the multiaxial kinematic mechanism and the pivot axis of the manipulator arm or the element of the multiaxial kinematic mechanism. Alternatively or additionally, it is conceivable for the piston-cylinder module to be mounted in such a manner by means of the guide that it can be shifted along the support element of the lifting device.

In an advantageous embodiment, the holding means for the load is attached to a free end of the manipulator arm by means of a vertical arm and an additional pivot joint having a vertical pivot axis, the holding means being able to pivot freely by manual force and/or by means of a positioning unit, in particular with a rotation angle limitation, about said additional pivot joint. The holding means and the load held thereon are located centrally under the additional pivot joint, which means that a pivoting about this additional pivot joint does not lead to any significant lateral acceleration or deceleration of the load. During a pivoting movement, it is primarily only the rotational mass moments of inertia that have to be overcome, which can happen by manual force and/or by means of an energy-efficiently operable positioning unit even in the case of heavier loads. An optionally provided rotation angle limitation can prevent twisting of a pneumatic line, an electrical supply and control line or another line due to an excessive pivot angle.

It is conceivable for two manipulator arms to be provided, in which case the second manipulator arm is mounted on a free end of the first manipulator arm by means of an associated pivot joint and can pivot about the associated pivot joint, in particular with a rotation angle limitation. This offers the option of having two superimposed pivoting movements, by means of which the worker can also effect translational movements of the load and thus move the load to any position within the radius of the lifting device. The rotation angle limitation prevents the second manipulator arm and the load held on it from colliding with a support element, for example. Moreover, it prevents pneumatic lines, electrical supply and control lines or other lines from twisting as a result of an excessive pivot angle.

In a second aspect, the invention relates to a method for manipulating a load by means of at least one lifting device, the method comprising the following steps:
fixing the load to a holding means,
lifting and/or holding the load at least by means of a weight compensation unit,
positioning the load by manual force and/or by means of a positioning unit,
   wherein the positioning of the load about at least one axis of movement and/or along at least one axis of movement is supported by a positioning unit associated with the at least one axis of movement and a weight compensation unit associated with the at least one axis of movement.

Thus, with the method according to the invention, the load to be positioned can be advantageously positioned with minimal drive energy per individual axis of movement by separating weight compensation and positioning. The association of at least one positioning unit and at least one weight compensation unit per axis of movement enables, in addition to the safe cooperation between the worker and the lifting device, the relief of the worker and a simple and sensitive positioning even of heavy loads. Preferably, the method according to the invention for manipulating a load can be employed with the lifting device according to the invention, or the lifting device according to the invention can be used to carry out the method according to the invention.

The weight compensation unit can be controlled in such a manner that only relatively low driving forces are exerted to position the load by means of the positioning unit. The driving forces exerted by means of the positioning unit can be small enough for bodily injury to be reliably minimized and/or excluded. The minimization of the driving forces of the positioning unit is made possible because the effect of the weight force is largely compensated for by means of the weight compensation unit. In addition, the number of drives required to position the load can thus be advantageously reduced. Due to the control of the weight compensation unit, the driving force having to be exerted by a positioning unit can advantageously be 5% to 20% compared to a driving force to be exerted by a positioning unit of a lifting device without a weight compensation unit. In other words, the driving force having to be exerted by the positioning unit can be reduced by 80% to 95%. Preferably, the driving force having to be exerted by a positioning unit can advantageously be 8% to 15%, in particular 10%, compared to a driving force having to be exerted by a positioning unit of a lifting device without a weight compensation unit.

The weight compensation unit can be regulated, in particular as a function of the position of the load, in such a manner that the force having to be exerted to position the load remains constant irrespective of the weight force and of the position of the load. In other words, this means that, provided that the positioning is carried out solely via the positioning unit, the positioning unit only has to exert a constant, minimal force irrespective of the weight force and of the position of the load in space. Should the force having to be exerted by the positioning unit increase due to the movement and/or the position of the load in space, the weight compensation unit can advantageously be adjusted in such a manner that the force having to be exerted by the positioning unit drops back below a desired threshold.

If the weight force of the load is known, the lifting of the load can take place at a higher speed than the subsequent positioning of the load. Thus, the cycle time of the positioning process can be reduced in an advantageous manner by moving the load to an advance position faster. The advance position is a position in space that is at least in the proximity of the target position of the load to which the load is to be moved. If the load is moved to the advance position quickly, only a short distance has to be traveled for the positioning of the load, which typically takes place at a lower speed, which means that the total time required for positioning the load can be reduced.

According to a preferred embodiment of the method, the weight force of the load can be determined and a set of control data for controlling the positioning unit and/or the weight compensation unit can be created as a function of the weight force of the load. In particular if the weight of the load is unknown, it is advantageous that the weight force of the load is determined, for example by means of a suitable sensor system. Alternatively or additionally, it is conceivable that if the weight of the load is known, the weight data are used to create a set of control data for controlling the positioning unit and/or the weight compensation unit as a function of the weight force of the load. Either as an alternative to or in addition to sensory detection, the weight data can be entered by the responsible worker via a control module and can be processed in the controller.

Measurement values can be acquired by means of a position sensor system, a speed sensor system, an acceleration sensor system, a time sensor system, a path sensor system and a weight sensor system, as previously described. These measurement values can be stored in a database, and/or a set of control data can be created as a function of the acquired measurement values. Preferably, a set of control data can be generated as a function of the measurement values of a weight sensor system, a time sensor system and/or a path sensor system, the force exerted by the weight compensation unit being matched to the position of the load in space and/or to the acceleration of the load in order to keep the force having to be exerted by the positioning unit as low as possible. A database preferably comprises at least one computer-readable storage medium.

According to an advantageous embodiment of the method according to the invention, sets of control data and measurement values can be stored in a linked manner in a database, in which case a statistical model can be created on the basis of the stored measurement values and sets of control data, and a new set of control data can be determined by inference with the statistical model. The linked storage of the sets of control data and measurement values in a database and/or the creation of a statistical model based on the stored measurement values and sets of control data and/or the determination of a new set of control data by inference with the statistical model can be carried out by means of the control module, which can have a computing unit, or by means of a central computing unit, which can be a computer. The control module can be disposed in the working space of the lifting device. The central computing unit can be disposed outside of the working space of the lifting device. It is conceivable that the central computing unit processes data from multiple lifting devices and creates and outputs sets of control data for a plurality of lifting devices. On the basis of the statistical model, statistical relationships between the sets of control data and the weight of the load can be recognized. In other words, the statistical model can be trained with the help of the recorded measurement values and the stored sets of control data, which can also be referred to as training data sets. Preferably, the training involves supervised learning, unsupervised learning or reinforcement learning. In a particular preferred case, the statistical model is an artificial neural network, in particular a recurrent neural network (RNN), a feedforward neural network (FNN), a convolutional neural network (CNN), a transformer, a flow-based generative model, an evolving neural network, an encoder-decoder model, a variational autoencoder, an autoregressive model (ARMA model), a restricted Boltzmann machine (RBM) and/or a diffusion model, a hidden Markov model (HMM) and/or a support vector machine (SVM). Furthermore, it is conceivable to use the methods of genetic programming, boosting, decision tree machine learning, kernel density estimation (KDE), expert system (ES), a (naive) Bayes classifier, gradient boosting, linear discriminant analysis, nearest neighbor classificator, a cluster analysis method, in particular the single-linkage method, the complete-linkage method, the Ward method, the K-means algorithm, the fuzzy-C-means algorithm, the expectation maximization algorithm (EM algorithm), DBSAN (density-based spatial clustering of applications with noise), the STING algorithm (statistical information grid-based clustering algorithm) and/or the CLIQUE algorithm (clustering inquest algorithm), and/or a method of anomaly detection, in particular the local outlier factor (LOF), the isolation forest and/or the autoencoder, and/or the principal component analysis (PCA). Furthermore, methods of reinforcement learning can be used, such as associated reinforcement learning, deep reinforcement learning, adversarial deep reinforcement learning, fuzzy reinforcement learning and/or safe reinforcement learning. In particular, it is conceivable that methods for clustering data will also be used.

The sets of control data and measurement values can be stored in a central database, the database being continuously expanded with new sets of control data and measurement values during operation of the lifting device and/or use of the method according to the invention. Based on the measurement values and sets of control data stored in the database, a new set of control data can be determined by inference with the statistical model. In this context, the term “inference” refers to the derivation of at least one new set of control data on the basis of the statistical model created with the measurement values and the already known sets of control data. By means of the further embodiment of the method, it is thus possible to quickly and easily create sets of control data for manipulating a load or to at least suggest them to a worker. Thus, a self-learning process can optimize the weighing and/or moving of the load to a desired position.

It is understood that the aforementioned and the following embodiments and configuration examples can be realized not only individually but also in any combination with each other without leaving the scope of the present invention. It is also understood that the aforementioned and the following embodiments and configuration examples equivalently or at similarly relate to the method according to the invention without being mentioned separately for the method.

### BRIEF DESCRIPTION OF THE DRAWING FIGURES

Embodiments of the invention are schematically illustrated in the drawings and are explained below by manner of example.

FIG. 1 shows a first schematic configuration example of a lifting device according to the invention; and

FIG. 2 shows a second schematic configuration example of a lifting device according to the invention.

### DETAILED DESCRIPTION

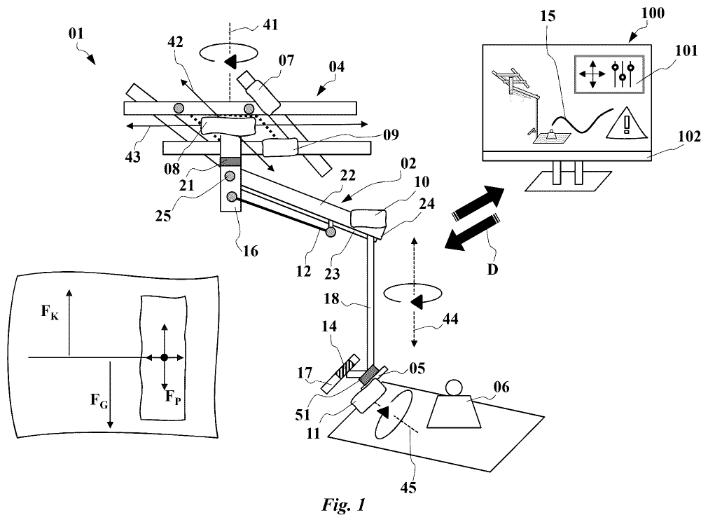

FIG. 1 shows a simplified illustration of a lifting device 01, which has a multiaxial kinematic mechanism 04 with a manipulator arm 02. At the free end 24 of the manipulator arm 02, a vertical arm 18 is disposed, at the free end of which a holding means 05 for receiving the load 06 is disposed. The manipulator arm 02 is mounted in a fixed place on a support element 16 by means of an associated pivot joint 21. In the case at hand, a support element is provided as a vertical support element 16, which can be firmly anchored to the ceiling or to a ceiling rail and is aligned in the direction of the weight force FG. The pivot joint 21 has a vertical axis of movement 41, which is also aligned in the direction of the weight force FG and on which the manipulator arm 02 can pivot. In the case at hand, no rotation angle limitation is provided at the pivot joint 21. However, it is quite conceivable to provide a rotation angle limitation at the pivot joint 21 to limit the angle of rotation. The holding means 05, which is disposed on the vertical arm 18, can pivot about the axis of movement 45 by means of the pivot joint 51. Furthermore, it is conceivable that the holding means 05 can perform additional functions on the load 06, such as tilting, lifting, shifting or the like.

The lifting device 01 is configured in such a manner that a worker can be in the immediate vicinity of the load 06 and of the holding means 05 and can manually manipulate the load 06 and move it into the desired position with the support of the positioning units 07, 08, 09, 10, 11. To do so, the worker can apply manual force to the load 06 or to the lifting device 01, in particular to the holding means 05 or to the vertical arm 18, or can control one of the positioning units 07, 08, 09, 10, 11 using the control module 17. As a result, a combined pivoting movement of the manipulator arm 02 about the associated pivot joint 21 can be brought about, whereby the load 06 can be guided laterally or in a pivoting movement parallel to the ground. Furthermore, the load 06 can be moved along and/or about the further axes of movement 42, 43, 44, 45 of the multiaxial kinematic mechanism 04 to position the load 06.

Moreover, the manipulator arm 02 has an additional pivot joint 25 at its end facing the support element 16, the additional pivot joint 25 having a horizontal axis of movement 46, which is a pivot axis, for adjusting the height of the load 06. For this purpose, the manipulator arm 02 of the configuration example shown is formed by a pair of vertically pivoting parallelogram arms 22, 23 disposed one above the other in the direction of the weight force FG, the pivot joint 25 being a double joint for the two parallelogram arms 22, 23. Accordingly, such a double joint can also be provided at the other end of the manipulator arm 02, i.e., at the end of the manipulator arm 02 facing the vertical arm 18. This allows the manipulator arm 02, including the load 06, to be adjusted in height to any intermediate position. The combination of horizontal and vertical pivoting and the possible movements along the axes of movement 41, 42, 43, 44, 45 results in the working space 19 within which the holding means 05 and the load 06 can be moved.

To support the worker, the positioning units 07, 08, 09, 10, 11, each of which has at least one positioning actuator, are associated with the axes of movement 41, 42, 43, 44, 45. Actuation of the corresponding positioning unit 07, 08, 09, 10, 11 causes a positioning force F_{P} to act on the multiaxial kinematic mechanism 04, which causes the load 06 to move about and/or along one of the axes of movement 41, 42, 43, 44, 45. For example, the positioning unit 08 is associated with the axis of movement 41 and causes a pivoting movement about the axis of movement 41 via the pivot joint 21. Furthermore, in the configuration example at hand, the positioning unit 10 is associated with the pivot axis 44, actuation of the positioning unit 10 causing the vertical arm 18 to pivot about the axis of movement 44. The axes of movement 42 and 43, which are shifting axes, are associated with the positioning units 07 and 09, actuation of which allows shifting the manipulator arm along the axes of movement 42 and 43 via the multiaxial kinematic mechanism 04. The holding means 05 can be rotated about the axis of movement 45 using the positioning unit 11.

The positioning units 07, 08, 09, 10, 11 can be controlled by the operator directly in the working space 19 via the control module 17 or they can be controlled from outside of the working space 19 by means of the central computing unit 100 since an exchange of data D can take place between the central computing unit 100 and the controller 14 and/or the control module 17. In order to keep the manipulator arm 02 in balance and to be able to operate the positioning units 07, 08, 09, 10, 11 as energy-efficiently as possible, at least one axis of movement 41, 42, 43, 44, 45 is assigned a weight compensation unit 12, which can comprise a piston-cylinder module as a weight compensation actuator. The weight compensation unit produces a counterforce acting on the manipulator arm 02, which in turn produces a counter-torque that opposes the load torque. The weight compensation unit 12 can be controlled by means of the controller 14 in such a manner that the counter-torque produced by the weight compensation unit 12 is equal to the load torque produced by the weight force FG of the load 06, whereby the manipulator arm 02 is kept in equilibrium. To rotate or lift and lower the load 06, the positioning units 07, 08, 09, 10, 11 therefore only have to exert a low force, which means that the positioning units 07, 08, 09, 10, 11 can be designed to be correspondingly weak and can be operated in an energy-efficient manner. In accordance with the configuration example at hand, the weight compensation unit 12 is associated with the axes of movement 41 and 44, about which the manipulator arm 02 and the vertical arm 18 can pivot without the weight force FG of the load 06 having to be overcome. The weight compensation unit 12 and the manipulator arm 02 are hinged to the support element 16 in such a manner that the manipulator arm 02 and the weight compensation unit 12 each have at least one vertical pivot axis, said axes running parallel to each other. The piston-cylinder module of the weight compensation unit 12 can be fixed to the manipulator arm 02 in a guide (not shown) in such a manner that it can be shifted transversely to the cylinder axis.

In an advantageous manner, the controller 14 can be used to control the weight compensation unit 12 in such a manner that, if the positioning force F_{P} to be exerted by one of the positioning units 07, 08, 09, 10, 11 to position the load 06 exceeds a threshold, meaning the positioning units 07, 08, 09, 10, 11 cannot be operated in the desired energy-efficient manner, the weight compensation unit 12 relieves the axis of movement 41, 42, 43, 44, 45 associated with the positioning unit 07, 08, 09, 10, 11. For example, the weight compensation unit 12 can be actuated as a function of the position of the load 06 in the working space 19. It is known that when the load 06 moves along a trajectory 15, the load torque varies depending on the position of the load 06 in the working space 19. In order to take account of this circumstance, the weight compensation unit 12 can be controlled in such a manner that the force having to be exerted to position the load 06 remains constant irrespective of the weight force FG and of the position of the load 06 in the working space 19.

The positioning units 07, 08, 09, 10, 11 and the weight compensation units 12, 13 can be controlled by means of a set of control data 101. The set of control data 101 can be created directly at the lifting device 01 by the controller 14 and can be adjusted by the worker or remotely from the lifting device 01 by a central computing unit 100 exchanging data D with the controller 14 and/or the control module 17. It is also conceivable that the planning of the trajectory 15 takes place in the central computing unit and a corresponding set of control data 101 comprising at least the trajectory 15 is output to the controller 14 and/or to the control module 17, meaning the positioning of the load 06 can take place at least semi-automatically or fully automatically. Furthermore, the lifting device 01 can have sensor systems (not shown), such as a position sensor system, a speed sensor system, an acceleration sensor system, a time sensor system, a path sensor system and a weight sensor system, which continuously or at regular intervals detect measurement values that are stored in a database 102. In this context, sets of control data 101, such as historical sets of control data used in the past for positioning a load 06, and measurement values can be stored in the database 102 in linked form, and the central computing unit 100 can create a statistical model on the basis of the stored measurement values and sets of control data 101, by means of which a new set of control data 101 can be determined by inference with the statistical model. Thus, continuous optimization of the positioning of a load 06 through machine learning can be made possible, and the worker can be largely relieved.

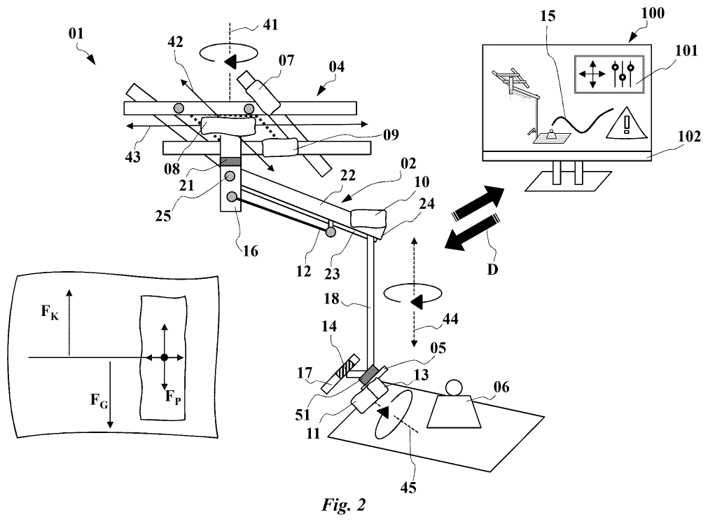

The lifting device 01 shown in FIG. 2 corresponds to the lifting device according to FIG. 1 except for the arrangement of the weight compensation units 12, 13, which is why reference is made to the description in this regard in order to avoid repetition. As can be seen, the lifting device according to the embodiment shown in FIG. 2 has two weight compensation units 12, 13. Each of the weight compensation units 12, 13 is associated with at least one of the axes of movement 41, 42, 43, 44, 45 to relieve the positioning units 07, 08, 09, 10, 11. The weight compensation unit 12 is associated at least with the axes of movement 41 and 44, and the weight compensation unit 13 is associated at least with the axis of movement 45. In the context of the invention, the weight force of the load 06 can thus advantageously be compensated for along multiple axes of movement 41, 42, 43, 44, 45 with a single weight compensation unit 12 and/or with multiple weight compensation units 12, 13 associated with at least one axis of movement 41, 42, 43, 44, 45.

### REFERENCE SIGNS

01 lifting device
02 manipulator arm
   21, 25 pivot joint
   22, 23 parallelogram arms
   24 free end of manipulator arm
03
04 multiaxial kinematic mechanism
   41, 42, 43, 44, 45 axis of movement
05 holding means
   51 pivot joint
06 load
07, 08, 09, 10, 11 positioning unit
12, 13 weight compensation unit
14 controller
trajectory
16 support element
17 control module
18 vertical arm
19 working space
100 central computing unit, e.g., computer
101 set of control data
102 database
D exchange of data

1. A lifting device (01) for manipulating a load (06), the lifting device (01) comprising a multiaxial kinematic mechanism (04) on which at least one manipulator arm (02) is mounted, the manipulator arm (02) being configured to move about or along multiple axes of movement (41, 42, 43, 44, 45) and having a holding means (05) for the load (06), wherein
a positioning unit (07, 08, 09, 10, 11) acting on the multiaxial kinematic mechanism (04) and serving to move the manipulator arm (02) and a weight compensation unit (12, 13) for compensating for the weight force (FG) of the load (06) are associated with at least one of the axes of movement (41, 42, 43, 44, 45).

2. The lifting device according to claim 1,
wherein
the weight compensation unit (12, 13) or the positioning unit (07, 08, 09, 10, 11) are configured to be driven electrically or pneumatically.

3. The lifting device according to claim 2,
wherein
the electrical or pneumatic drive of the weight compensation unit (12, 13) or of the positioning unit (07, 08, 09, 10, 11) is configured in such a manner that the drive meets the requirements of collaborative robotics.

4. The lifting device according to claim 1, wherein the lifting device (01) comprises a controller (14) configured to control the movement of the manipulator arm (02) as a function of the weight force (FG) of the load (06) or of the position of the load (06) or of the trajectory (15) of the manipulator arm (02).

5. The lifting device according to claim 1, wherein
the controller (14) is configured to dynamically compensate for the weight force (FG) of the load (06).

6. The lifting device according to claim 1, wherein the lifting device (01) comprises a position sensor system, a speed sensor system, an acceleration sensor system, a time sensor system, a path sensor system or a weight sensor system.

7. The lifting device according to claim 1, wherein
the weight compensation unit (12, 13) comprises a fall arrester.

8. The lifting device according to claim 1, wherein the multiaxial kinematic mechanism (04) has a pivot joint (21) associated with the manipulator arm (02), the pivot joint (21) having a vertical axis of movement (41), about which the manipulator arm (02) is pivotable, the manipulator arm (02) being mounted in a fixed placeby means of the associated pivot joint (21).

9. The lifting device according to claim 1, wherein
the manipulator arm (02) is formed by vertically pivoting parallelogram arms (22, 23) disposed one above the other in the direction of the weight force (F).

10. The lifting device according to claim 1, wherein
a control module (17) operable by a user is disposed in the area of the holding means (05) for the load (06).

11. The lifting device according to claim 1, wherein
the lifting device (01) comprises a guide allowing the weight compensation unit (12) to be shifted perpendicular to a longitudinal axis of the weight compensation unit (12).

12. The lifting device according to claim 1, wherein the holding means (05) for the load (06) is attached to a free end (24) of the manipulator arm (02) by means of a vertical arm (18) and an additional pivot joint (51) having an axis of movement (45), which is a pivot axis, the holding means (05) being configured to pivot freely, about the additional pivot joint (51).

13. A method for manipulating a load (06) by means of at least one lifting device (01), the method comprising the following steps:
fixing the load (06) to a holding means (05),
lifting or holding the load (06) at least by means of a weight compensation unit (12, 13), and
positioning the load (06) by manual force or by means of a positioning unit (07, 08, 09, 10, 11),
wherein the positioning of the load (06) about at least one axis of movement (41, 42, 43, 44, 45) or along at least one axis of movement (41, 42, 43, 44, 45) is supported by a positioning unit (07, 08, 09, 10, 11) associated with the at least one axis of movement (41, 42, 43, 44, 45) and by a weight compensation unit (12, 13) associated with the at least one axis of movement (41, 42, 43, 44, 45).

14. The method according to claim 13,
wherein the weight compensation unit (12, 13) is controlled in such a manner that relatively low drive forces, which minimize or exclude bodily injury, have to be exerted in order to position the load (06) by means of the positioning unit (07, 08, 09, 10, 11).

15. The method according to claim 13,
wherein the weight compensation unit (12, 13) is controlled in such a manner that the force having to be exerted in order to position the load (06) remains constant irrespective of the weight force (FG) and of the position of the load (06).

16. The method according to claim 13,
wherein, with the weight force (FG) of the load (06) known, the lifting of the load (06) takes place at a higher speed than the positioning of the load (06).

17. The method according to claim 13, wherein the weight force (FG) of the load is determined, and a set of control data (101) for controlling the positioning unit or the weight compensation unit as a function of the weight force (FG) of the load is created.

18. The method according to claim 13, wherein measurement values of a position sensor system, a speed sensor system, an acceleration sensor system, a time sensor system, a path sensor system or a weight sensor system are acquired, and the measurement values are stored in a database (102), or a set of control data (101) is created as a function of the measurement values.

19. The method according to claim 18,
wherein sets of control data (101) and measurement values are stored in the database (102) in a linked manner, and a statistical model is created on the basis of the stored measurement values and of the stored sets of control data (101), and a new set of control data (101) is determined by inference with the statistical model.
